(19) United States
(12) Patent Application Publication
(10) Pub. No.: US 2002/0044761 A1
(43) Pub. Date: Apr. 18, 2002

(54) Transmitting apparatus of image information, transmssion system, and transmitting method

(76) Inventors: Yoshikazu Takashima, Tokyo (JP); Motoki Kato, Kanagawa (JP); Toshiya Hamada, Saitama (JP)

Correspondence Address: FROMMER LAWRENCE & HAUG LLP, 745 FIFTH AVENUE, New York, NY, 10151, US

(21) Appl. No.: 09/943,128

(22) Filed: Aug. 29, 2001

(30) Foreign Application Priority Data
Aug. 31, 2000 (JP) 2000-263996

(51) Int. Cl. H04N 5/783

(52) U.S. Cl. 386/68; 386/111

(57) ABSTRACT

A bit stream is converted into an ES by a demultiplexer 12. The ES is decoded by a decoder 13 and becomes a digital video signal and displayed on a monitor 14. In case of outputting an MPEG stream of a trick play, in an output control unit 16, an output mode such as FF, FR, slow reproduction, or the like is determined and information of the output mode is supplied to an analyzing/rewriting unit 15. The analyzing/rewriting unit 15 reads the stream on a picture unit basis, analyzes a picture header, and executes processes necessary for realizing the output mode according to the mode information from the output control unit 16. In case of outputting the trick play stream, in order to obtain the bit stream adapted to the MPEG standard, a value of temporal_reference in the picture header is rewritten to a correct value and a value of vbv_delay is invalidated. A trick play output which satisfies encoding regulations is generated, thereby enabling the stream of the trick play output to be decoded by an existing decoder.

### BACKGROUND OF THE INVENTION

1. Field of the Invention

The invention relates to a transmitting apparatus, a transmission system, and a transmitting method of image information which is applied to rerecord an MPEG (Moving Picture Experts Group) video signal recorded on a recording medium.

2. Description of the Related Arts

In case of displaying a trick play image onto a monitor on the basis of an MPEG video signal recorded on a recording medium such as a disk or the like, a digital video signal decoded by an MPEG decoder is once stored into a memory, a frame to be displayed is selected (that is, the presence or absence of a display is determined), or the number of times of display of the same frame is adjusted.

It is also possible that an MPEG bit stream of a trick play is outputted through a digital interface such an IEEE (Institute of Electrical and Electronics Engineers) 1394 or the like, and it is recorded by an external recording apparatus or decoded by an external reproducing apparatus and displayed. In this case, hitherto, information indicative of a reproducing mode such as still, FF, FR, slow reproduction, or the like which is executed on the transmission side is sent by header information of an ISO (International Organization for Standardization)/IEC (International Electrotechnical Commission) 13818-1 system stream, so that such a trick play can be realized. FF denotes a fast forward reproduction and FR indicates a fast reverse reproduction. Specifically speaking, the information indicative of the reproducing mode such as still, FF, FR, slow reproduction, or the like is described in a DSM_trick_mode field (DSM: Digital Storage Media) in the header information of a PES (Packetized Elementary Stream) packet. The system stream formed as mentioned above is transmitted from the transmission side to the reception side through the digital interface.

A decoder corresponding to the DSM_trick_mode of the header information of the PES packet hardly exists actually. Therefore, a method of outputting the MPEG stream of the trick play to the digital interface in a form such that it can be decoded by an existing decoder is demanded for the existing decoder.

### OBJECTS AND SUMMARY OF THE INVENTION

It is, therefore, an object of the invention to provide a transmitting apparatus, a transmission system, and a transmitting method of image information, in which a stream of a trick play can be outputted in a form such that it can be reproduced by an existing decoder.

According to the first aspect of the invention, there is provided a transmitting apparatus for converting a coded bit stream into a trick play output and sending it to a transmission path, comprising:

accumulating means for accumulating the coded bit stream including an intra-frame coded picture, a forward predictive-coded picture, and a bidirectionally predictive-coded picture;

output control means for controlling so as to output the coded bit stream in an output mode corresponding to a designated trick play operation;

rewriting means for rewriting control data which specifies a displaying order of the pictures with respect to the coded bit stream;

picture forming means for forming a picture obtained by copying a predetermined picture; and

output means for outputting a picture whose control data has been rewritten and the formed picture in accordance with the control of the output control means.

According to the second aspect of the invention, there is provided a transmission system of image information, comprising:

accumulating means for accumulating a coded bit stream including an intra-frame coded picture, a forward predictive-coded picture, and a bidirectionally predictive-coded picture;

output control means for controlling so as to output the coded bit stream in an output mode corresponding to a designated trick play operation;

rewriting means for rewriting control data which specifies a displaying order of the pictures with respect to the coded bit stream;

picture forming means for forming a picture obtained by copying a predetermined picture;

output means for outputting a picture whose control data has been rewritten and the formed picture as trick play output data in accordance with the control of the output control means;

a digital interface connected to the output means; and

an apparatus for recording or displaying the trick play output data received through the digital interface.

According to the third aspect of the invention, there is provided a transmitting method of image information for converting a coded bit stream into a trick play output and sending it to a transmission path, comprising:

an accumulating step of accumulating a coded bit stream including an intra-frame coded picture, a forward predictive-coded picture, and a bidirectionally predictive-coded picture;

an output control step of controlling so as to output the coded bit stream in an output mode corresponding to a designated trick play operation;

a rewriting step of rewriting control data which specifies a displaying order of the pictures with respect to the coded bit stream;

a picture forming step of forming a picture obtained by copying a predetermined picture; and

an output step of outputting a picture whose control data has been rewritten and the formed picture in accordance with the output control.

According to the invention as mentioned above, the output coded bit stream as a trick play output can be formed by a process for the coded bit stream, and the output coded bit stream can be decoded by the existing decoder.

The above and other objects and features of the present invention will become apparent from the following detailed description and the appended claims with reference to the accompanying drawings.

### BRIEF DESCRIPTION OF THE DRAWINGS

FIG. 1 is a block diagram showing a construction of an embodiment of the invention;

FIG. 2 is a schematic diagram for use in explanation of a skip P picture;

FIG. 3 is a schematic diagram for use in explanation of a search picture stream in the embodiment of the invention;

FIG. 4 is a flowchart for use in explanation of an output process of the search picture stream in the embodiment of the invention;

FIGS. 5A and 5b are schematic diagrams for use in explanation of an FF stream and an FR stream in the embodiment of the invention;

FIG. 6 is a flowchart for use in explanation of an output process of the FF stream and FR stream in the embodiment of the invention;

FIG. 7 is a schematic diagram for use in explanation of the FF stream using an I picture and a P picture in the embodiment of the invention;

FIG. 8 is a flowchart for use in explanation of an output process of the FF stream using the I picture and P picture in the embodiment of the invention;

FIG. 9 is a schematic diagram for use in explanation of a slow reproduction stream using the I picture and P picture in the embodiment of the invention;

FIG. 10 is a flowchart for use in explanation of an output process of the slow reproduction stream using the I picture and P picture in the embodiment of the invention;

FIG. 11 is a schematic diagram for use in explanation of a slow reproduction stream using all of the pictures in the embodiment of the invention;

FIG. 12 is a flowchart for use in explanation of an output process of the slow reproduction stream using all of the pictures in the embodiment of the invention; and

FIG. 13 is a schematic diagram for use in explanation of a still reproduction stream using the I picture in the embodiment of the invention.

### DETAILED DESCRIPTION OF THE PREFERRED EMBODIMENT

An embodiment of the invention will now be described hereinbelow with reference to the drawings. According to the embodiment, data is outputted correctly on the MPEG standard through a digital interface such as an IEEE1394 or the like, and an MPEG stream of a trick play which can be reproduced by an existing external decoder is formed. A format of the MPEG stream on the IEEE1394 is assumed to be a transport stream (hereinafter, referred to as a TS).

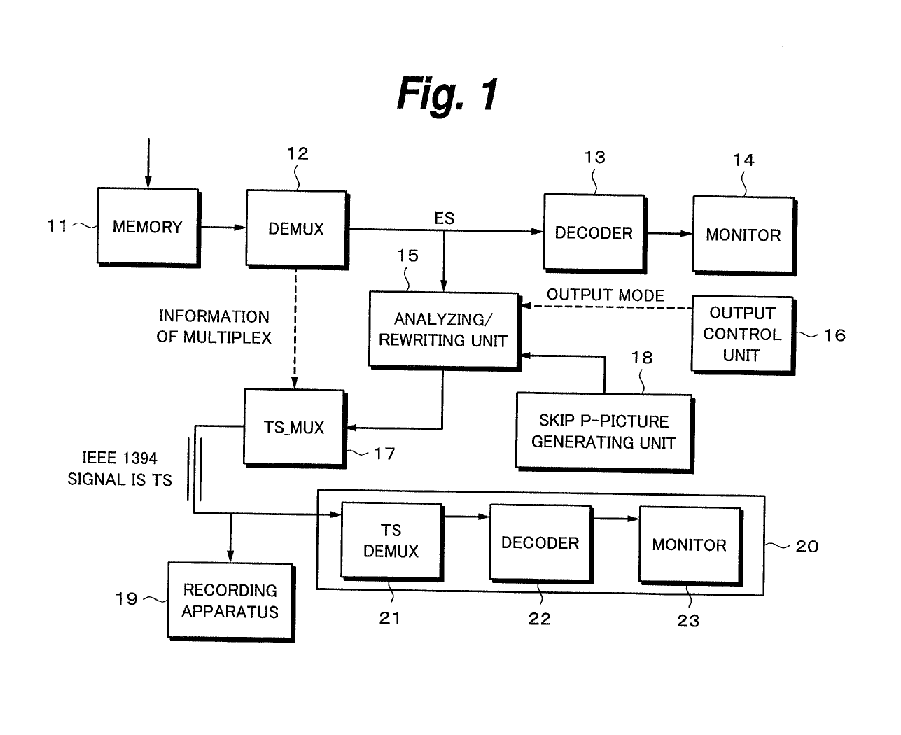

FIG. 1 shows the whole construction of a recording and reproducing apparatus in the embodiment. A coded bit stream such as video signal of satellite broadcast from a set-top box (not shown), video signal encoded by the MPEG format from a digital VTR, or the like is first once accumulated into a memory 11. The memory 11 is a general name representing a recording medium such as hard disk, optical recording disk, or the like as well as a semiconductor memory. The MPEG video signal which is accumulated in the memory 11 can be either in a state where it has been multiplexed in a form of the TS or a program stream (hereinafter, abbreviated to PS) or in a state of an elementary stream (hereinafter, abbreviated to ES) which is not multiplexed. The video signal in case of the satellite broadcast is, for example, data of one program.

When the signal accumulated in the memory 11 is extracted, if the signal has been multiplexed, it is converted into the ES by a demultiplexer (in FIG. 1, it is expressed as DEMUX) 12. The ES is decoded by a decoder 13, becomes a digital video signal, and is displayed on a monitor 14. Since the stream on the IEEE1394 has the TS format, in the case where the MPEG stream recorded in the memory 11 in the TS format is outputted by an IEEE1394 interface, it can be directly outputted to the IEEE1394. If the stream has been recorded by a form other than the TS, it is converted into the ES and subsequently multiplexed by a TS multiplexer (in FIG. 1, it is expressed as TSMUX) 17. An output of the TS multiplexer 17 is sent to the IEEE1394.

In case of outputting the MPEG stream of the trick play to the IEEE1394, in an output control unit 16, an output mode such as FF, FR, slow reproduction, or the like is determined and information indicative of the output mode is supplied to an analyzing/rewriting unit 15. For example, the output mode is designated by a key operation of the user, or the like. The analyzing/rewriting unit 15 reads the stream on a picture (frame) unit basis, analyzes a picture header, and executes processes, which will be explained hereinlater, in order to realize the output mode according to the mode information from the output control unit 16.

The kinds of pictures specified in the MPEG will now be described. The I picture (Intra-coded picture) uses information closed only in that one picture when it is encoded. Therefore, upon decoding, the data can be decoded only by the information of the I picture itself. The P picture (forward predictive-coded picture) uses the time-precedent I picture or P picture which has already been decoded, as a predictive picture (picture serving as a reference to get a difference). In a mode to encode a difference between the present picure and the motion compensated predictive picture and a mode to encode the picture without getting the difference, the mode of higher efficiency is selected on a macroblock unit basis. The B picture (Bidirectionally predictive-coded picture) uses three kinds of pictures: that is, a time-precedent I picture or P picture which has already been decoded, a time-subsequent I picture or P picture which has already been decoded, and an interpolation picture formed from both of those pictures, as a predictive picture (image serving as a reference to get a difference). The encoding of the highest efficiency between the encoding of the difference after the motion compensation of each of those three kinds of pictures and the intra-coding is selected on a macroblock unit basis.

Therefore, as macroblock types, there are an intra-frame coded macroblock, an inter-frame predictive macroblock in the forward direction in which the future is predicted from the past, an inter-frame predictive macroblock in the backward direction in which the past is predicted from the future, and bidirectional predictive macroblock which is predicted from both forward and backward directions. All of the macroblocks in the I picture are intra-frame coded macroblocks. The intra-frame coded macroblock and the forward inter-frame predictive macroblock are included in the P picture. The macroblocks of all of the foregoing four types are included in the B picture.

Further, there is a skipped macroblock (SB) as a macroblock which does not belong to those types of the macroblocks. In case of the P picture, the SB is a non-MC (simple inter-frame prediction) and is a macroblock which does not need the encoding (Not Coded: which does not have a DCT coefficient).

The analyzing/rewriting unit 15 reads the stream into a buffer on a picture (frame) unit basis, analyzes a picture header, and executes the following processes in order to realize the output mode in accordance with the mode information from the output control unit 16.

If the read picture is not outputted, the buffer is cleared. For example, a process for preventing the pictures other than the I picture from being outputted.

In case of forming a stream such that the same picture is displayed plural times in the slow reproduction or the like, a skip P picture (shown by Ps) and a copy B picture (shown by Bc) are used. The skip P picture is generated by a skip P picture generating unit 18 and its detailed description will be also explained hereinlater. The copy B picture will be explained hereinlater. If the picture to be displayed is the I or P picture, the skip P picture is outputted so that it can be displayed subsequently to the original picture. If the picture to be displayed is the B picture, the copy B picture is outputted so that it can be displayed subsequently to the original picture.

That is, in case of repetitively displaying the I picture, the pictures are outputted like IPsPsPs . . . instead of outputting like IIII . . . . In case of repetitively displaying the P picture, the pictures are outputted like PPsPsPs . . . instead of outputting like PPPP . . . . In case of repetitively displaying the B picture, the pictures are outputted like BBcBcBc. . . instead of outputting like BBBB. . . . In the MPEG, however, the order of the pictures which are outputted is determined in consideration of a point that the order of the pictures in the bit stream and the order of the pictures which are actually displayed are different.

In case of outputting the picture, the following two processes are executed to convert into the bit stream adapted to the MPEG standard. First, a value of temporal_reference in the picture header is rewritten to a correct value. temporal_reference denotes a displaying order of the pictures in a GOP (Group Of Picture). If the value is outputted without being rewritten, it will infringe the MPEG standard.

Subsequently, a value of vbv_delay (accumulation amount of a virtual input buffer of a decoder) in the picture header is rewritten to 0×FFFF. This value is a code indicative of invalidity of vbv_delay. The reason why the rewriting is executed is because, at the time of a trick play, since the order of the pictures has been changed from the original order, if the original value of vbv_delay is used as it is, a wrong result is obtained.

Before an output from the analyzing/rewriting unit 15 is supplied to the IEEE1394 interface, it is multiplexed to the TS format by the TS multiplexer 17. If the stream which is being handled has inherently been recorded by the TS format into the memory 11, it is desirable to perform the TS multiplex by making the most of information (PID (packet ID), service_id, etc.) of the multiplex which can be obtained when converting the stream into the ES by the demultiplexer 12. For this purpose, the multiplex information held in the demultiplexer 12 is sent to the TS multiplexer 17.

A recording apparatus 19 and a monitoring apparatus 20 built in the MPEG decoder are connected to the IEEE1394 interface. The recording apparatus 19 records the signal on the IEEE1394. The monitoring apparatus 20 comprises: a TS demultiplexer (TS DEMUX) 21 for receiving the signal from the IEEE1394 interface; an MPEG decoder 22 connected to the TS demultiplexer 21; and a monitor 23 for reproducing a video and/or an audio signal(s) from the MPEG decoder 22. The signal sent through the IEEE1394 interface can be reproduced by the monitoring apparatus 20.

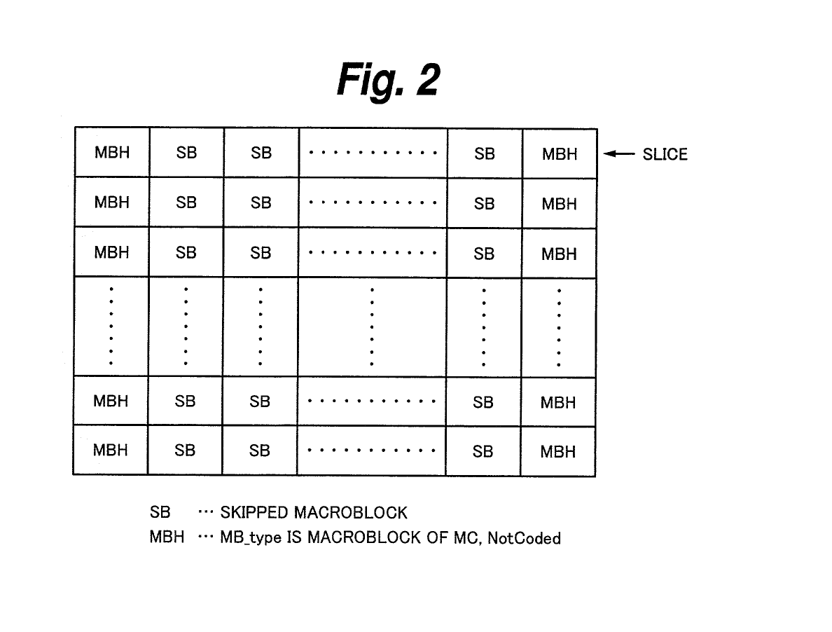

The pictures which are used for the trick play MPEG stream will now be described. First, the skip P picture will be explained. The skip P picture is a P picture having a structure shown in FIG. 2. One block in FIG. 2 shows a macroblock (also properly shown by MB). Since the macroblocks at both ends of a slice cannot be omitted according to the regulations of the MPEG, macroblock_type is converted into a mactoblock of MC, NotCoded (MB such that MB address information and a motion vector of (0, 0) are transmitted and no DCT coefficient is transmitted) and all of the other macroblocks are converted into skipped macroblocks (also properly shown by SB). The decoder which received the skip P picture outputs substantially the same digital video signal as that obtained by decoding the just-previous I or P picture.

Although the skip P picture is generated by the skip P picture generating unit 18 in FIG. 1, in the skip P picture generating unit 18, the skip P picture which has previously been held in an ROM or the like can be also read out, or a sequence header in a bit stream is analyzed, a picture frame is examined, and a skip P picture suitable for this picture frame can be also generated and used.

The copy B picture will now be described. The copy B picture is a copy of the just-previous B picture. By sending the copied B picture plural times, the same picture can be displayed many times by the external reproducing apparatus.

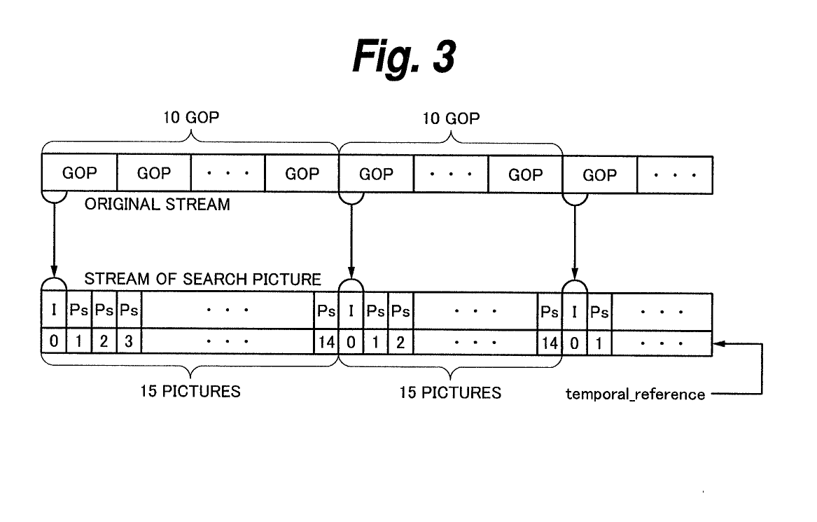

Several specific examples of the generation of the trick play bit stream will be described hereinbelow. A search picture will be first explained. FIG. 3 shows the original stream and the stream of the search picture. The head I picture is outputted every one or more GOPs and, thereafter, the skip P picture Ps are repetitively outputted the necessary number of times. FIG. 3 shows an example in the case where the head I picture is outputted every 10 GOPs and, thereafter, the skip P picture is outputted 14 times. When n (the number of pictures in the GOP of the original stream)=15, a search picture such that one picture is extracted at intervals of 5 seconds (10 GOPs) and displayed at intervals of 0.5 second is realized.

If the head address of the GOP on the memory is known by some method, by searching the I picture backwardly and outputting it, and thereafter, outputting the skip P picture of the necessary number, a bit stream of a backward search picture can be also generated.

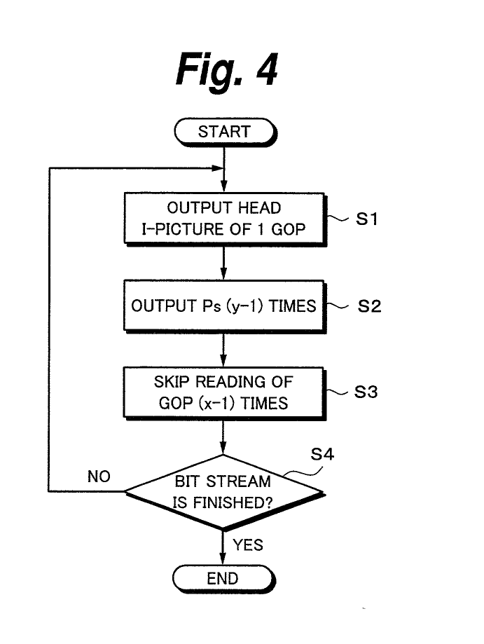

FIG. 4 is a flowchart for outputting to allow one I picture of every×GOPs to be displayed every frames of y times. In first step S1, the I picture at the head of one GOP is outputted. Subsequently, the skip P picture Ps is outputted (y−1) times. In the example of FIG. 3, y−1=14.

In step S3, the reading of the GOP is skipped (x−1) times. In the example of FIG. 3, x−1=9. In step S4, whether the bit stream has been finished or not is determined. If it is not finished, steps S1, S2, and S3 are repeated. When it is determined that the stream has been finished, the processing routine is finished.

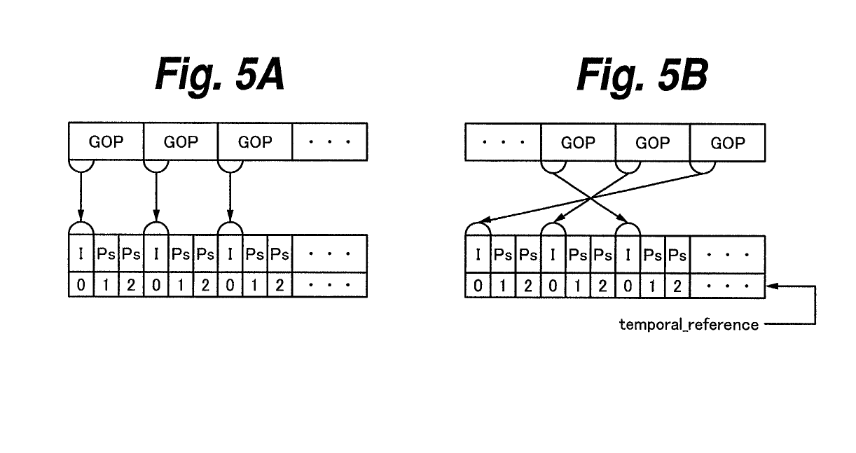

Processes of the FF and FR will now be described. FIG. 5A shows the original stream and the stream of the FF. FIG. 5B shows the original stream and the stream of the FR. In the FF and FR, the I picture is outputted every GOP and, thereafter, the skip P picture Ps is repetitively outputted the necessary number of times. A speed of the FF or the FR can be determined by the number of repeating the skip P picture. As an interval of the I pictures which are outputted is shorter, a bit rate becomes higher. Therefore, it is necessary to consider a processing speed of the decoder and a bit rate which can be used in the digital interface.

FIG. 5A shows an example of the case where the I picture of every GOP is displayed every three frames. The case of n=15 corresponds to the FF of the display at a speed of 5-times. As shown in FIG. 5B, by reversing the extracting order of the I pictures, the FR is realized.

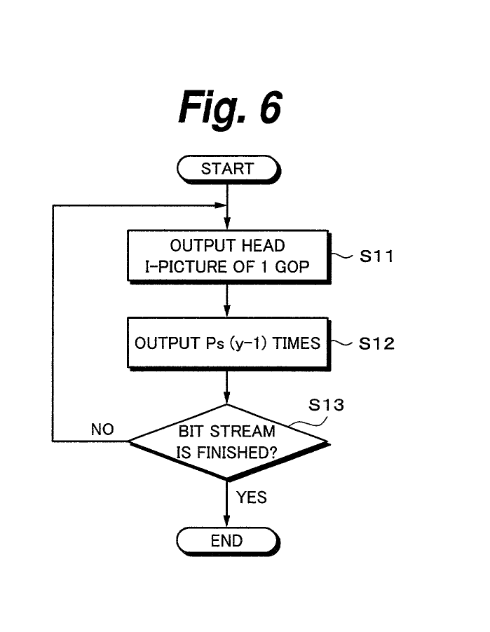

FIG. 6 is a flowchart showing processes for outputting to allow the I picture of every GOP to be displayed every frames of y times. In first step S11, the I picture at the head of one GOP is outputted. Subsequently, the skip P picture Ps is outputted (y−1) times. In step S13, whether the bit stream has been finished or not is determined. If it is not finished yet, steps S11 and S12 are repeated. If it is decided that the bit stream has been finished, the processing routine is finished.

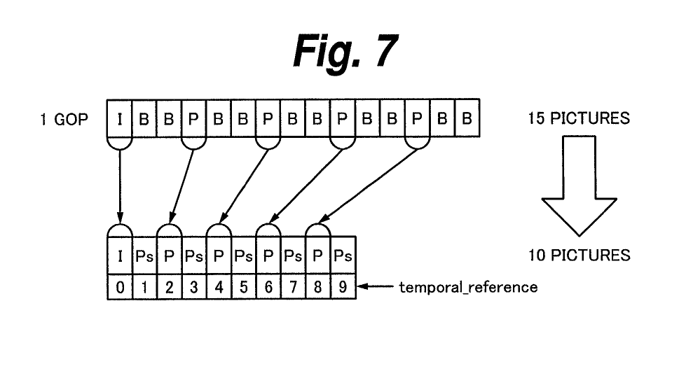

With respect to the FF, the P picture besides the I picture is also outputted. By outputting the skip P pictures of the necessary number after each picture, the FF display that is smoother than that in case of displaying only the I picture can be realized. FIG. 7 shows an example in case of displaying the I picture and P picture twice at a time on the basis of a stream having a GOP structure of n=15 and m=3. In this case, the reproduction is performed at a speed of 1.5 times. If no skip P picture is outputted, the 3-times speed is set in case of m=3. m denotes a period at which the I or P picture appears. If the number of P pictures which are used is limited, the FF of a further higher speed can be also realized. In this case, as P pictures which are used, to which number the P pictures are displayed in an order close to the I picture can be selected. In the case where the P pictures on the halfway are excluded, the P pictures after the excluded P pictures in the GOP cannot be outputted.

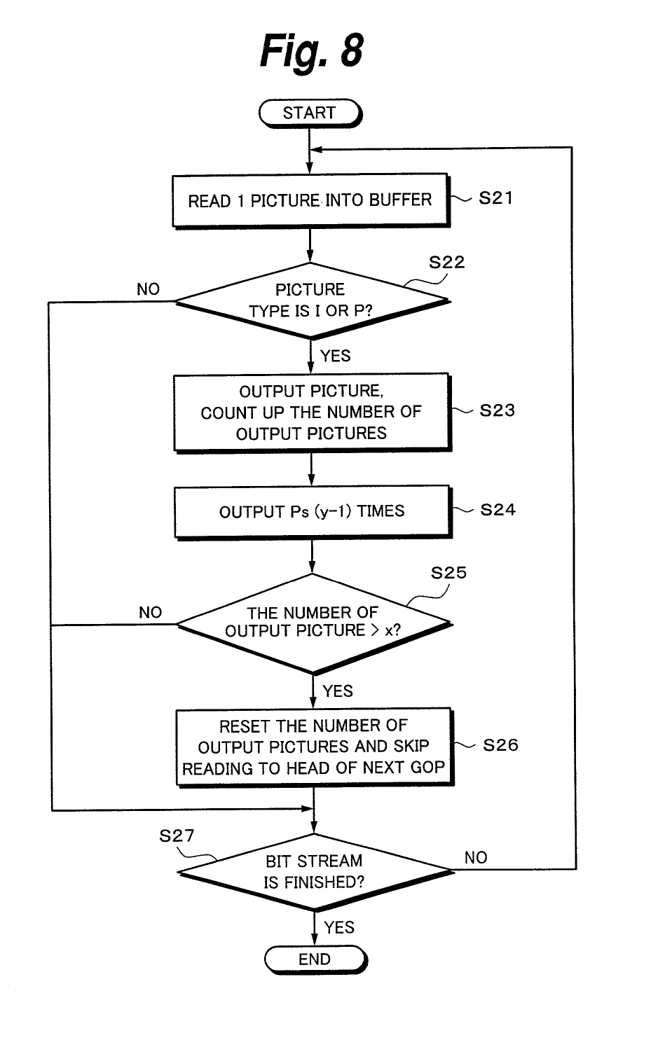

FIG. 8 is a flowchart for outputting to allow the I picture of every GOP and the P pictures up to the xth picture to be displayed every frames of y times. In first step S21, one picture is read out and stored into the buffer. Whether the type of the read picture is I or P is determined in step S22. If it is neither I nor P, the processing routine advances to step S27 (whether the bit stream has been finished or not is determined).

If it is decided that the picture type is I or P, in step S23, the picture is outputted and a count value of the number of output pictures is increased. In step S24, the skip P picture Ps is outputted (y−1) times.

In step S25, whether the count value of the number of output pictures is larger than x or not is determined. If the count value of the number of output pictures does not reach x, whether the bit stream has been finished or not is determined in step S27. If it is not finished yet, the processing routine is returned to step S21. If it is decided that the bit stream has been finished, the processing routine is finished. If the number of output pictures is equal to or larger than x in step S25, in step S26, the count value of the number of output pictures is reset and the reading is skipped to the head of the next GOP. The processing routine advances to step S27.

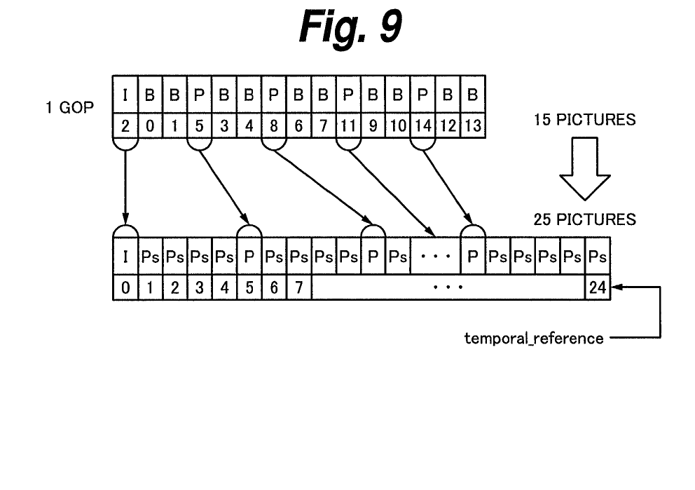

Processes for the slow reproduction will now be described. The following two kinds of methods can be used with respect to the slow reproduction. According to the first method, in the FF processes described with reference to FIG. 5A, in case of using the I picture and the P picture, the number of skip P pictures which are outputted after each picture is set to a value larger than m. Assuming that an interval between the I pictures and that between the P pictures after the insertion of the skip P pictures are set to x, a speed of m/x times can be realized. However, in the case where the slow reproduction is performed by this method, no B picture is displayed. FIG. 9 shows an example in the case where a stream of x=5 (every four skip P pictures are inserted) is outputted on the basis of the bit stream of m=3 and the slow reproduction is performed at a speed of 3/5 time.

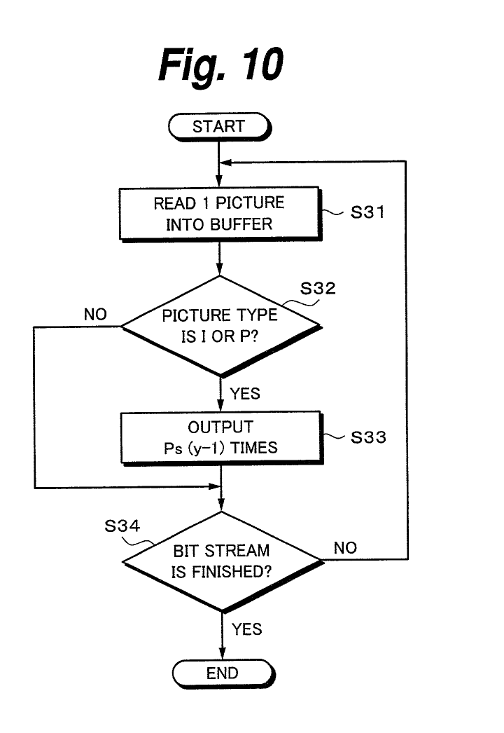

FIG. 10 is a flowchart showing processes for outputting to allow the I picture and the P picture to be displayed every frames of y times. In first step S31, one picture is read out and stored into the buffer. Whether the type of the read picture is I or P is determined in step S32. If it is neither I nor P, the processing routine advances to step S34 (whether the bit stream has been finished or not is determined).

In case of the I or P picture, the skip P picture Ps is outputted (y−1) times in step S33. In step S34, whether the bit stream has been finished or not is determined. If it is not finished yet, the processing routine is returned to step S31. If it is decided that the bit stream has been finished, the processing routine is finished.

The second method of the slow reproduction will now be described. The second method intends to realize the slow reproduction by displaying all of the pictures plural times. According to the second method, with respect to each of the I and P pictures, the skip P picture is continuously displayed. With respect to the B picture, the copied B picture is continuously displayed. By displaying one picture plural times as mentioned above, the slow reproduction is realized.

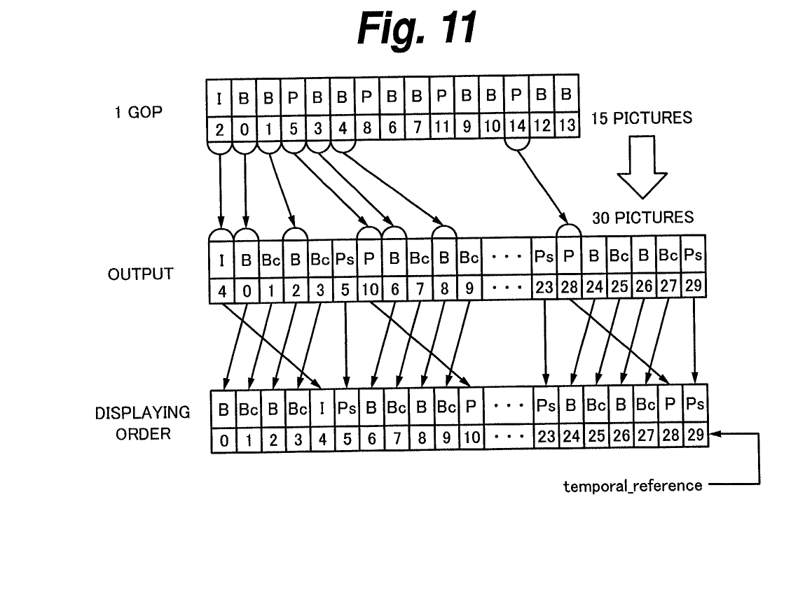

FIG. 11 shows an example in the case where the speed of 1/2 time is realized by displaying all of the pictures twice. Therefore, the original 15 pictures are converted into 30 pictures. It is necessary to consider the order of the pictures in the bit stream so as to obtain a desired displaying order. The display is performed in the order shown by rewritten temporal_reference.

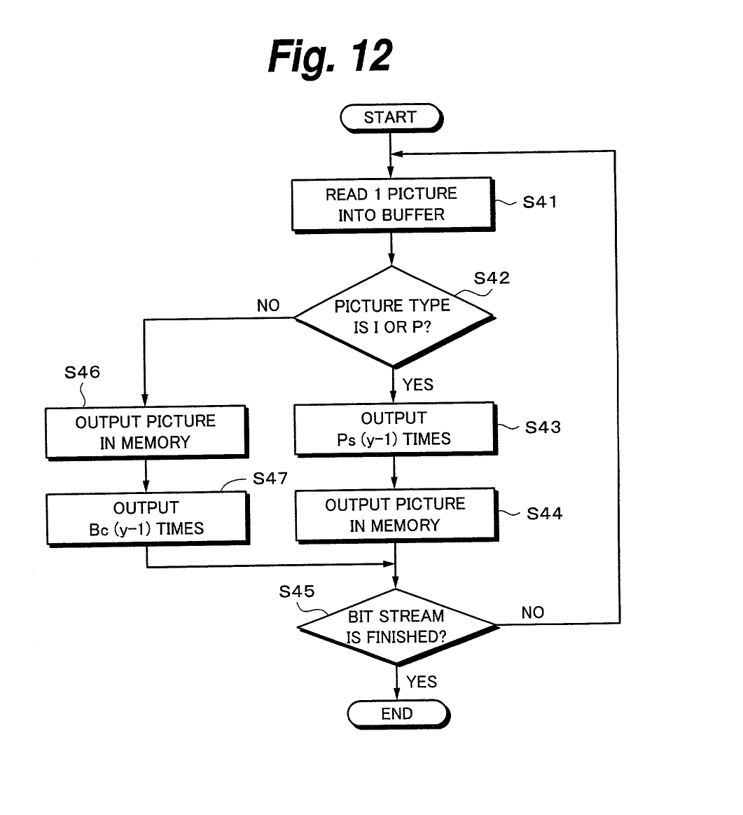

FIG. 12 is a flowchart showing processes for outputting to allow all of the pictures to be displayed every frames of y times. In first step S41, one picture is read out and stored into the buffer. Whether the type of the read picture is I or P is determined in step S42. In case of the I or P picture, the skip P picture Ps is outputted (y−1) times in step S43. In next step S44, the pictures in the memory are outputted. In step S45, whether the bit stream has been finished or not is determined. If it is not finished yet, the processing routine is returned to step S41. If it is decided that the bit stream has been finished, the processing routine is finished.

If it is decided in step S42 that the picture type is neither I nor P, the pictures in the memory are outputted in step S46. Instep S47, the copy B picture Bc is outputted (y−1) times. The processing routine advances to the process for deciding whether the bit stream has been finished or not in step S45.

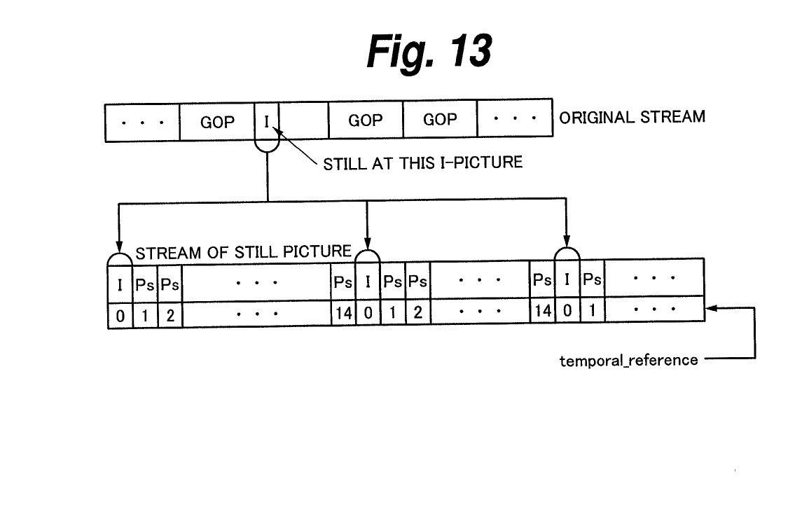

The processes of the still reproduction will now be described. The following three kinds of methods can be used with respect to the still reproduction. According to the first method, in case of performing the still reproduction by the I picture, a GOP structure in which after the I picture is outputted, a predetermined number of skip P pictures are inserted is repetitively outputted. FIG. 13 shows an example in the case where a GOP structure in which after the I picture, 14 skip P pictures are continuously inserted is repetitively sent. The reason why the output is set to the GOP structure is to consider a random access property and easiness of edition in case of rerecording on the output destination side.

According to the second method, the still reproduction is performed by the P picture. In this case, the skip P picture is continuously sent after the P picture. According to the third method, the still reproduction is performed by the B picture. In this case, after the B picture, the same B picture is continuously sent. When the still reproduction is performed by the P picture and B picture and a still picture having the GOP structure is outputted as mentioned above, the process for converting the P picture or B picture into the I picture such as a process for performing the reencoding or the like is necessary.

Although the embodiment has been described above with respect to the MPEG as an example of the encoding, the invention is not limited to the MPEG but can be also applied to a coded stream in which the intra-frame coded picture and the predictive coded picture exist mixedly.

According to the invention, the digital data of the trick play can be outputted to the digital interface in a form such that it can be decoded by the existing decoder. Specifically speaking, the bit streams of the search, FF, FR, slow reproduction, and still reproduction can be outputted.

The present invention is not limited to the foregoing embodiment but many modifications and variations are possible within the spirit and scope of the appended claims of the invention.

What is claimed is:

1. A transmitting apparatus for converting a coded bit stream into a trick play output and sending it to a transmission path, comprising:
accumulating means for accumulating the coded bit stream including an intra-frame coded picture, a forward predictive-coded picture, and a bidirectionally predictive-coded picture;
output control means for controlling so as to To output the coded bit stream in an output mode corresponding to a designated trick play operation;
rewriting means for rewriting control data which specifies a displaying order of the pictures with respect to said coded bit stream;
picture forming means for forming a picture obtained by copying a predetermined picture; and
output means for outputting a picture whose control data has been rewritten and said formed picture in accordance with the control of said output control means.

2. An apparatus according to claim 1, wherein said predetermined picture is the intra-frame coded picture or the forward predictive-coded picture, the copied picture is outputted as a skip P picture having a structure such that macroblocks other than macroblocks at both ends of a slice are skipped.

3. An apparatus according to claim 1, wherein as for the picture which is outputted, said rewriting means makes data indicative of an accumulation amount of a virtual input buffer of a decoder in a picture header invalid.

4. An apparatus according to claim 1, wherein the coded bit stream by the trick play operation is outputted by repeating processes for outputting the intra-frame coded picture and, thereafter, outputting a plurality of copies pictures.

5. An apparatus according to claim 1, wherein by repeating processes such that after the intra-frame coded picture and the forward predictive-coded picture which repetitively appear at intervals (m), the copied pictures of the number larger than said (m) are outputted, the coded bit stream by a slow operation is outputted.

6. An apparatus according to claim 1, wherein the coded bit stream by a slow operation is formed so that the copied pictures are displayed subsequently to each of all pictures in the coded bit stream.

7. A transmission system of image information, comprising:
accumulating means for accumulating a coded bit stream including an intra-frame coded picture, a forward predictive-coded picture, and a bidirectionally predictive-coded picture;
output control means for controlling so as to output the coded bit stream in an output mode corresponding to a designated trick play operation;
rewriting means for rewriting control data which specifies a displaying order of the pictures with respect to said coded bit stream;
picture forming means for forming a picture obtained by copying a predetermined picture;
output means for outputting a picture whose control data has been rewritten and the formed picture as trick play output data in accordance with the control of said output control means;
a digital interface connected to said output means; and
an apparatus for recording or displaying the trick play output data received through said digital interface.

8. A transmitting method of image information for converting a coded bit stream into a trick play output and sending it to a transmission path, comprising:
an accumulating step of accumulating a coded bit stream including an intra-frame coded picture, a forward predictive-coded picture, and a bidirectionally predictive-coded picture;
an output control step of controlling so as to output the coded bit stream in an output mode corresponding to a designated trick play operation;
a rewriting step of rewriting control data which specifies a displaying order of the pictures with respect to said coded bit stream;
a picture forming step of forming a picture obtained by copying a predetermined picture; and
an output step of outputting a picture whose control data has been rewritten and said formed picture in accordance with said output control.
